(19) United States
(12) Patent Application Publication
(10) Pub. No.: US 2022/0129909 A1
(43) Pub. Date: Apr. 28, 2022

(54) VESSEL DETENTION PREVENTION AND RISK ASSESSMENT SERVICE

(71) Applicant: Shipmetrics Technology LLC (DE LLC), Dulles, VA (US)

(72) Inventors: Alfonso Castillero, Rockville, MD (US); Stephen Frey, Bayville, NY (US)

(21) Appl. No.: 17/077,040

(22) Filed: Oct. 22, 2020

(51) Int. Cl. G06Q 30/00; G06Q 50/26; G06Q 10/06; G06Q 50/18; G06Q 10/10; G01C 21/20

(52) U.S. Cl. CPC G06Q 30/018; G06Q 50/265; G06Q 10/0635; G01C 21/203; G06Q 10/10; G06Q 10/06316; G06Q 50/18

(57) ABSTRACT

A method, a device, and a non-transitory storage medium provide a vessel detention prevention and risk assessment service. The service may determine whether a vessel has a detention risk upon arrival at a next destination. The service may initiate actions to be taken to minimize or prevent the detention risk before arrival. The service may also calculate an overall risk of the vessel based on registry data, port state control data, and/or class society data.

### BACKGROUND

A maritime registry may assist shipowners and operators in various aspects of (international) marine transport. The maritime registry is responsible to ensure that vessels are compliant with flag and international regulations, such as those relating to inspection, certification, and safety over the vessels registered under its flag. For example, vessels are subject to a port state control (PSC) inspection and/or other inspections by other entities to ensure that the vessel operates in compliance with applicable international, regional and/or local laws, regulations, and/or conventions. Vessels that do not meet international requirements may be detained by PSC authorities. A detained vessel is unable to continue its voyage until identified issues or findings are rectified, which may cause additional costs for the vessel operators and owners.

### BRIEF DESCRIPTION OF THE DRAWINGS

FIG. 1 is a diagram illustrating an exemplary environment in which an exemplary embodiment of a vessel detention prevention and risk assessment service may be implemented;

FIGS. 2A-2G are diagrams illustrating an exemplary process of an exemplary embodiment of the vessel detention prevention and risk assessment service;

FIGS. 3A-3G are diagrams illustrating another exemplary process of an exemplary embodiment of the vessel detention prevention and risk assessment service;

FIG. 4 is a diagram illustrating exemplary components of a device that may correspond to one or more of the devices illustrated herein;

FIG. 5 is a flow diagram illustrating an exemplary process of the vessel detention prevention and risk assessment service; and

FIG. 6 is a flow diagram illustrating another exemplary process of the vessel detention prevention and risk assessment service.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Maritime registries and other entities may assist in ensuring compliance with regulations, laws, conventions, and/or requirements to which a vessel or a ship (referred to herein as “vessel”) may be subject. For example, the vessel may need to be registered when over 100 Gross Tons (GTs) irrespective of whether the vessel is a cargo vessel, a passenger vessel, or some other type of vessel. There are various types of registries, such as an open registry, a second national registry, an offshore registry, or another type of registry.

The maritime registry may assist various operators and/or vessels (e.g., worldwide, regionally, etc.) and may assist in assuring compliance with international laws, conventions (e.g., International Convention for the Safety of Life at Sea (SOLAS), International Convention for the Prevention of Pollution from Ships (MARPOL), International Convention on Standards of Training, Certification and Watchkeeping for Seafarers (STCW), and other conventions), various PSC entities (e.g., U.S. Coast Guard, foreign PSC entities, etc.), a Memorandum of Understanding (MoU) (e.g., Paris MoU, Tokyo MoU, Indian Ocean MoU, Australian MoU, Black Sea MoU, and other MoU), and/or other types of requirements. Depending on the type or category of vessel (e.g., bulker, tanker, container, offshore, general cargo, passenger, specialty, or other type), the type of cargo (e.g., chemical, passenger, dry, liquid, refrigerated, special, unitized, etc.), and other factors (e.g., location of the vessel, etc.), the selection and application of a given regulation, law, convention, an MoU, or requirement may be impacted.

Managing and actively monitoring a fleet of vessels for compliance issues can include the collection and analysis of an inordinate amount of data. Depending on the circumstances, a vessel may be detained, may be subject to an unscheduled inspection, may be boarded by a PSC Officer or other enforcement entity, and/or subject to enforcement of other items of business that may impact the operation of the vessel, the operator, and other entities or items of relevance. The ability to prevent or minimize these issues, for example, and other issues from occurring, is complex.

According to exemplary embodiments, a vessel detention prevention and risk assessment service is described. According to an exemplary embodiment, the vessel detention prevention and risk assessment service may determine a risk of detention for a vessel. For example, the risk of detention for the vessel may be determined based on current and historical information associated with the vessel and configurable criteria, as described herein. For a vessel with a determined risk of detention, according to an exemplary embodiment, the vessel detention prevention and risk assessment service may actively monitor the vessel, may automatically schedule a preemptive inspection, alert a person associated with the vessel to schedule an inspection, and/or may invoke other actions designed to at least minimize if not prevent a prospective detention of the vessel.

According to an exemplary embodiment, the vessel detention and risk assessment service may determine a risk ranking of a vessel. For example, the vessel detention and risk assessment service may determine an overall risk associated with the vessel. According to an exemplary embodiment, the risk of the vessel may be ranked relative to other vessels. Rankings of risk may be categorized into various tiers or levels of risk, for example. According to an exemplary embodiment, the vessel detention and risk assessment service may generate the risk ranking based on current and historical information associated with the vessel and configurable criteria, as described herein. According to various exemplary embodiments, the overall risk may relate to multiple facets of operation associated with the vessel, as described herein. According to an exemplary embodiment, the vessel detention and risk assessment information may provide a ranking of the vessel of an operator compared to other vessels of other operators, and/or a vessel summary that indicates a profile of the vessel and associated risks.

In view of the foregoing, the vessel detention and risk assessment service may mitigate risk relating to the operation of vessels. Additionally, the service may improve vessel performance, compliance, and reputation; reduce costs associated with off-hire circumstances and delays; minimize possibilities of detention; minimize the chance of an inspection and/or the duration of the inspection; increase appeal success in case of detention; and/or other benefits that may naturally flow from this service. Detained vessels also negatively impact a flag's PSC ranking in that jurisdiction. Thus, it is in the flag's best interest to ensure each vessel's compliance so as to limit the number of PSC detentions and protect and/or improve the flag's ranking relative to other flags.

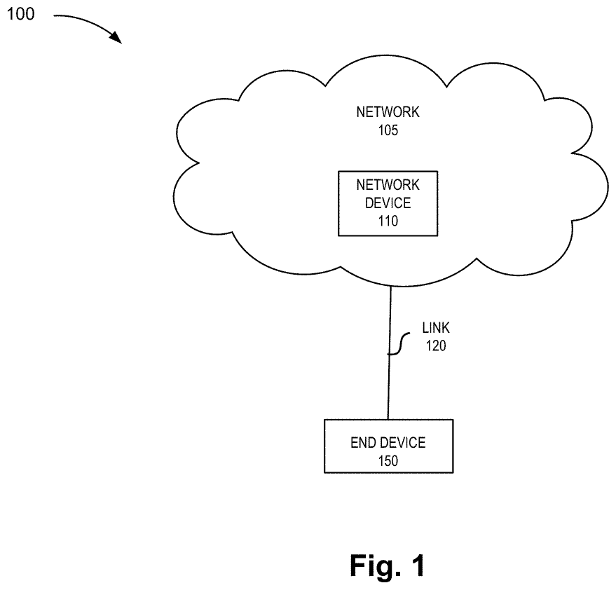

FIG. 1 is a diagram illustrating an exemplary environment 100 in which an exemplary embodiment of the vessel detention prevention and risk assessment service may be implemented. As illustrated, environment 100 includes a network 105, a network device 110, and an end device 150. Environment 100 includes a link 120 between network 105 and end device 150.

Network 105 may include one or multiple networks of one or multiple types and technologies. For example, network 105 may be implemented to include an access network (e.g., a radio access network (RAN), a WiMax network, a Wi-Fi network, etc.), a core network, an optical network, the Internet, a satellite network, a mobile network, a wired network, a local area network (LAN), a wide area network (WAN), a service provider network, an Internet Protocol (IP) network, a cloud network, a private network, a public network, a virtual network, and/or another type of network that provides access to and use of network 110 and the vessel detention prevention and risk assessment service.

Network device 110 may include a device that has computational and communicative capabilities. Network device 110 may be implemented to include a computer or some other type of computational and communicative device. According to some exemplary implementations, network device 110 may be included in an operations support system (OSS), a business support system (BSS), or other type of support system. According to an exemplary embodiment, network device 110 may store and manage information that supports the vessel detention prevention and risk assessment service, as described herein.

End device 150 may include a device that has computational and communicative capabilities. End device 150 may be implemented as an end user device, a mobile device, a stationary device, a portable device, or any other type of device. By way of further example, end device 150 may be implemented as a smartphone, a mobile phone, a personal digital assistant, a tablet, a netbook, a phablet, a wearable device (e.g., a watch, glasses, etc.), a computer (e.g., a desktop, a laptop, a palmtop, etc.), a device in a ship or vessel, a device in a vehicle, or other type of device that may provide access to and use of the vessel detention prevention and risk assessment service. End device 150 may include software that provides a communication service, such as email, text, voice, and/or other type of communication that enables end device 150 to transmit and/or receive messages or other types of notifications relating to the vessel detention prevention and risk assessment service. End device 150 may include software that provides an interactive environment with the vessel detention prevention and risk assessment service, such as a browser or other type of client. End device 150 may include software that permits end device 150 to query and/or retrieve information stored by or accessible via network device 110, as described herein.

A network device, such as network device 110, may be implemented according to a centralized computing architecture, a distributed computing architecture, or a cloud computing architecture (e.g., an elastic cloud, a private cloud, a public cloud, etc.). Additionally, end device 150 and/or network device 110 may be implemented according to one or multiple network architectures (e.g., a client device, a server device, a peer device, a proxy device, and/or a cloud device).

The number of end devices, the number of networks, the network of network devices, and the configuration in environment 100 are exemplary. According to other embodiments, environment 100 may include additional devices and/or differently arranged devices, than those illustrated in FIG. 1. For example, according to other embodiments, network device 110 may be implemented as multiple network devices in which a process or a function may be collaboratively performed or multiple processes or functions may be split between them.

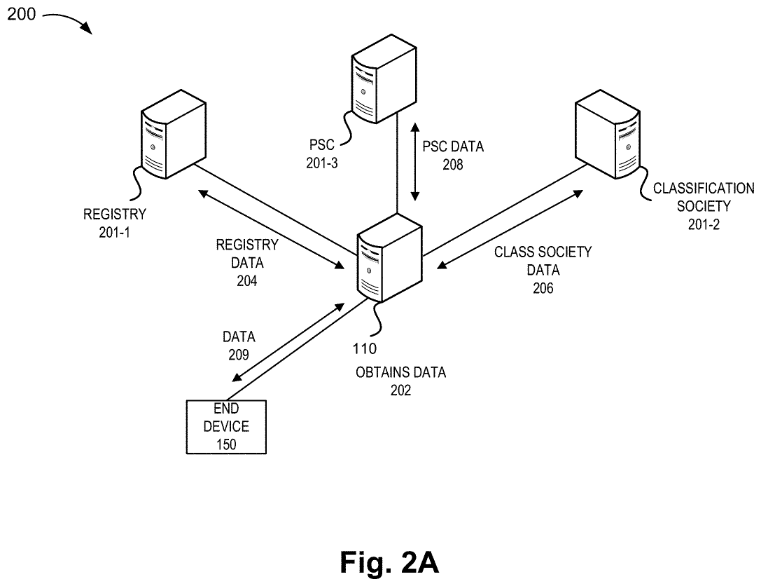

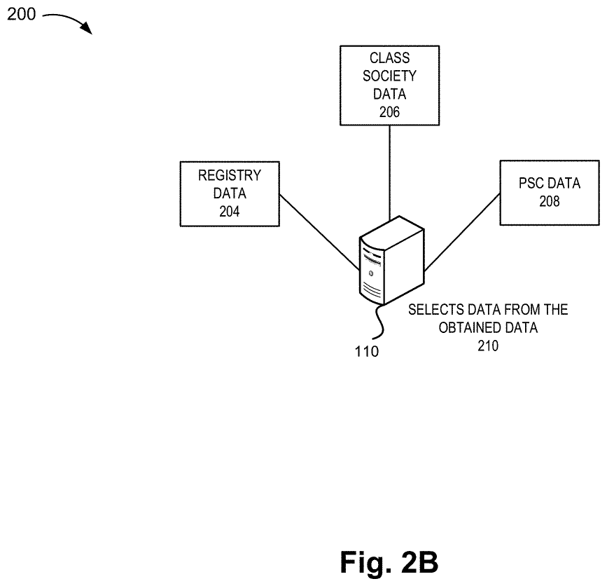

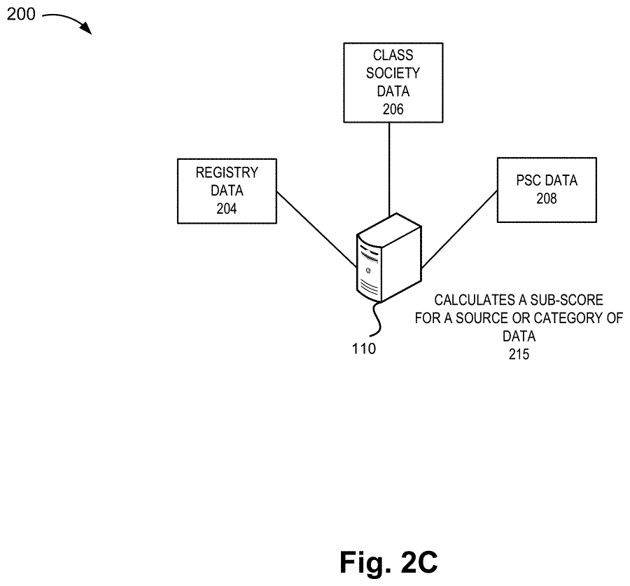

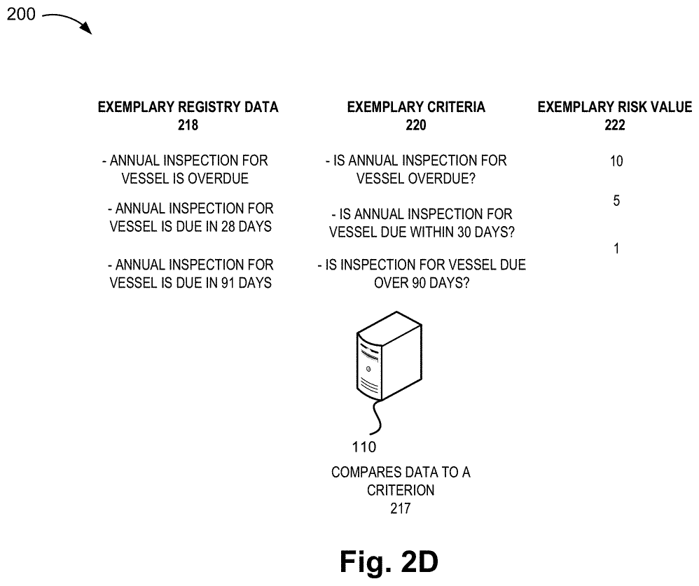

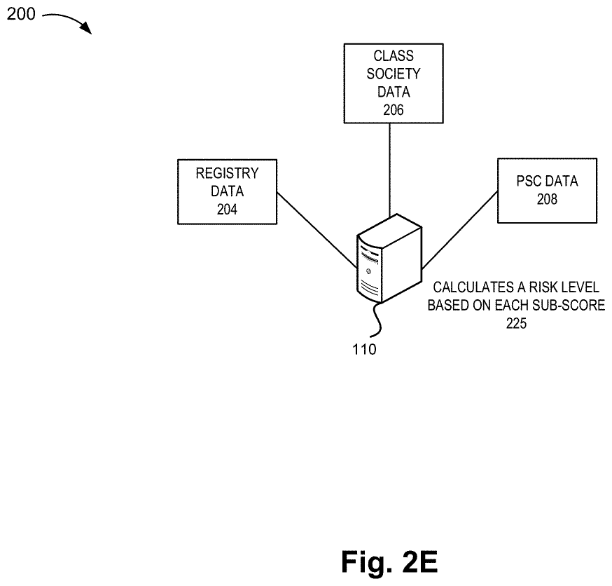

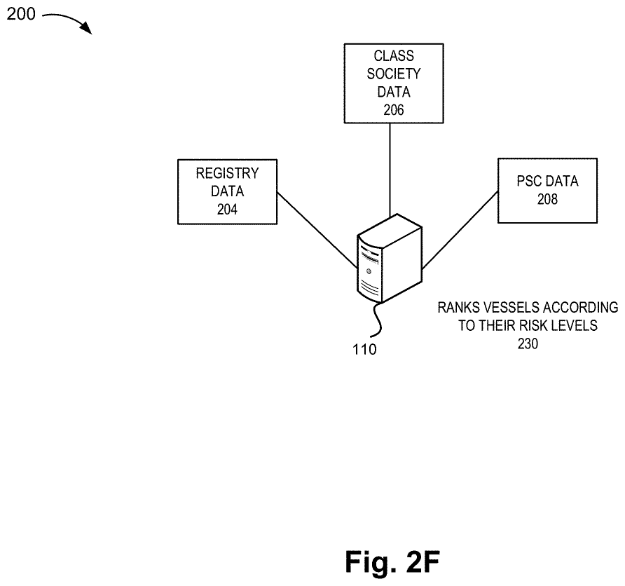

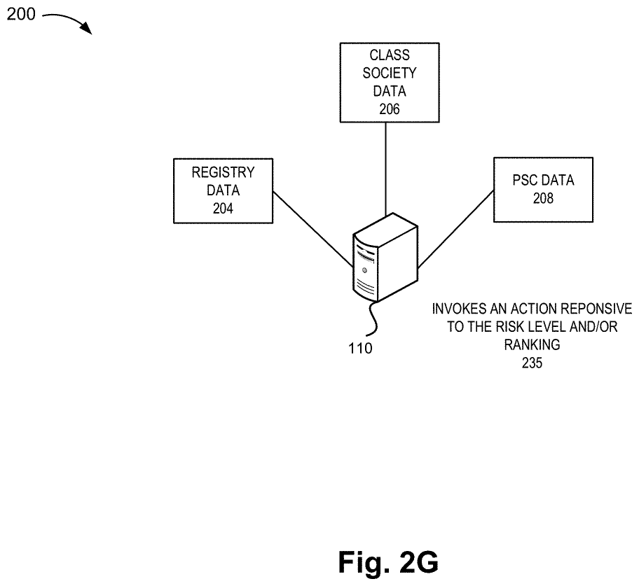

FIGS. 2A-2G are diagrams illustrating an exemplary process 200 of the vessel detention prevention and risk assessment service. As previously described, the vessel detention and risk assessment service may determine a risk level of a vessel. For example, the risk level may indicate an overall or generalized risk level attributable to the vessel. According to an exemplary embodiment, the risk level of the vessel may be ranked relative to other vessels in a fleet. For example, the risk level may be categorized into various tiers or categories of risk. By way of further example, the level of risk may be labeled as low, medium, high, or highest. According to other examples, the levels of risk may include a different number of risk tiers and/or use nomenclature different from low, medium, high, or highest to indicate a degree of risk. According to even other examples, the levels of risk may be quantified numerically (e.g., by a single numerical value or within a range of numerical values), may include the use of different colors to indicate varying levels of risk (e.g., white, green, yellow, red, and/or another color), or some other type of configurable indicators of risk levels or tiers.

According to an exemplary embodiment, process 200 or a step of process 200 may be performed periodically, such as daily or according to some other type of schedule. According to an exemplary embodiment, process 200 or a portion of process 200 may be automated. According to another exemplary embodiment, process 200 or a step of process 200 may be performed in response to a triggering event or non-periodically. For example, an administrator of the vessel detention prevention and risk assessment system, as described herein, may invoke process 200 or a step of process 200.

Referring to FIG. 2A, network device 110 may obtain data 202 from various data sources, such as network devices associated with a registry entity 201-1, a classification society entity 201-2, and a PSC entity 201-3. According to an exemplary embodiment, network device 110 may obtain registry data 204, class society data 206, and PSC data 208 using a push or pull method of communication with the network devices associated with entities 201-1, 202-2, and 201-3. In some cases, an authorized user (not illustrated) may provide data 209 to network device 110 via end device 150. For example, the authorized user may have access to data 209 that is not otherwise available from other sources. For the sake of description, there may be multiple classification society entities 201-2 and multiple PSC entities 201-3.

The instances of registry data 204, class society data 206, and PSC data 208 described herein are exemplary. Registry entity 201-1 may be a maritime registry entity for a fleet of vessels and the source of registry data 204. Network device 110 may be associated with registry entity 201-1. The source of class society data 206 may be a (maritime) classification society entity 201-2. For example, classification society entity 201-2 may establish and maintain technical standards for construction and operation of marine vessels, and may perform inspections and/or surveys of vessels to ensure compliance with set standards. Examples of a classification society entity 201-2 may include the American Bureau of Shipping, Bureau Veritas, China Classification Society, Polish Register of Shipping, among others. The source of PSC data 208 may be a PSC entity 201-3, such as the U.S. Coast Guard or a foreign Coast Guard that enforces laws, regulations, and/or an MoU associated with a particular country, region, national port, zone, or other geographic water area, or a third party supplier of such data.

Registry data 204 may include various types of data. For example, registry data 204 may include data relating to flag-directed inspections, related-inspection deficiencies of the vessel and/or operator relating to inspections, laws, regulations, and/or conventions over a configurable time period, such as six months, 1 year, or another time period. By way of further example, registry data 204 may include an age of the vessel; the shipyard where the vessel was built; the recognized organization that classed the vessel; the gross tonnage of the vessel; the type of vessel; when the vessel was last inspected; whether or not there are findings or issues identified during an inspection that may require correction; the average number of deficiencies for the vessel over a time period; whether or not there are any active dispensations relating to the findings or issues; what are the nature of the findings or issues that may require correction; whether or not correction of an active dispensation overdue; whether an inspection of the vessel is due within a short period of time (e.g., within 30 days or some other user-configurable time period); whether the vessel has outstanding fees; the days sales outstanding/speed of payment of issued invoices for the vessel; vessel casualties and crew accidents; Maritime Labour Convention (MLC) complaints; the location of the vessel; destination of the vessel, if any; laws, regulations, and/or conventions associated with the destination; compliance of the vessel (e.g., currently or upon arrival) with the laws, regulations, and/or conventions associated with the destination; and/or certifications issued by a registry pertaining to the vessel. Registry data 204 may include bank-related information, such as data relating to a mortgage for a vessel, whether a payment is overdue, whether the vessel is subject to foreclosure, and/or other bank-related information that may be of relevance to the vessel or an indicator of a risk, for example. According to other exemplary implementations, registry data 204 may include additional, fewer, and/or different instances of data that may be used to calculate a risk level of the vessel, as described herein.

Class society data 206 may include various types of data. For example, class society data 206 may include data relating to validity of certificates issued on behalf of the flag, inspections conducted on behalf of the flag, related inspection deficiencies, memorandum, and/or class recommendations of the vessel and/or operator relating to inspections, laws, regulations, and/or conventions over a configurable time period. For example, class society data 206 may include data associated with an inspection of the vessel or other types of reports or surveys that may relate to sea-worthiness, safety, structure, machinery, equipment, classification, certification, operational performance, and/or evaluation of the vessel. Class society data 206 may include compliance information and dispensation information (e.g., active, resolved, etc.) relating to the vessel and associated laws, regulations, and/or conventions.

According to other exemplary implementations, class society data 206 may include additional, fewer, and/or different instances of data that may be used to calculate a risk level of the vessel, as described herein.

PSC data 208 may include various types of data. For example, PSC data 208 may include data associated with an inspection of the vessel or other types of reports or surveys that may relate to sea-worthiness, safety, structure, classification, certification, operational performance, and/or evaluation of the vessel and equipment, as well as ensure that the vessel is manned and operated in compliance with laws, regulations, and/or conventions. PSC data 208 may include compliance information, PSC inspection information, related inspection deficiencies of the vessel and/or operator relating to inspections, and detention information relating to the vessel and associated laws, regulations, and/or conventions.

According to other exemplary implementations, PSC data 208 may include additional, fewer, and/or different instances of data that may be used to calculate a risk level of the vessel, as described herein.

According to other exemplary implementations, network device 110 may obtain data from additional, different, and/or fewer sources/entities of relevance to vessels and/or operators, and/or additional or different types of data. For example, network device 110 may obtain data from a source/entity such as an insurance company. The insurance company may provide data relating to insurance for a vessel, whether payment is overdue, whether policy coverage is about to expire, and/or other insurance-related information that may be of relevance to the vessel or an indicator of risk, for example. According to still other examples, even other sources/entities or different types of data may be obtained, such as maritime notices, industry and trade news, bulletins, or other types of information, which may be public, private, or other, which may relate to current or future circumstances, that may be of relevance to the vessel detention prevention and risk assessment service, as described herein.

Referring to FIG. 2B, network device 110 may select data from one or multiple sources of data 210. For example, network device 110 may select some or all of the data associated with a source or a category of data to be used as a basis to calculate a risk level, as described herein. According to an exemplary embodiment, the selection of which data instance to be used may be a configurable parameter of the vessel detention prevention and risk assessment service.

Referring to FIG. 2C, network device 110 may calculate a sub-score for a source or category of data. For example, network device 110 may include a risk assessment algorithm that calculates a sub-score to the selected instances of data associated with each source, a category of data (e.g., inspection-related, vessel detention related, etc.), which may or may not include data from multiples sources (e.g., inspection data associated with the registry (e.g., annual inspection) and/or inspection data associated with a PSC entity (e.g., PSC inspection data)). According to some exemplary embodiments, the sub-score may be a numerical value. According to some exemplary embodiments, each instance of selected data associated with the source may be equally weighted in calculating the sub-score. For example, if network device 110 uses x instances of selected data, each instance of data may contribute 1/x to the sub-score. According to other exemplary embodiments, each instance of data associated with the source may not be equally weighted in calculating the sub-score.

Referring to FIG. 2D, the risk assessment algorithm may include criteria or rules to determine a risk value. The criteria or rules may be configurable in terms of number and substance (e.g., category of data, source of data (e.g., registry data, PSC data, etc.)). The risk assessment algorithm of network device 110 may include logic that compares a selected instance of data to a criterion or rule. For illustration and the sake of description, assume for example that registry data 204 may include one of exemplary registry data 218 for a vessel, such as an annual inspection for the vessel is overdue, an annual inspection for the vessel is due in twenty-eight (28) days, or an annual inspection for the vessel is due in ninety-one (91) days. The due dates illustrated and described are exemplary. Also assume for example, that the risk assessment algorithm may include exemplary criteria 220 to calculate a risk value, such as: is annual inspection for vessel overdue?; is annual inspection for vessel due within the next thirty (30) days?; and is annual inspection due for the vessel over ninety (90) days? Criteria 220 is exemplary and is provided for illustration and the sake of description. According to other exemplary implementations, registry data 204 and criteria 220 may relate to how long a time period since the last inspection. The longer the time period the higher the risk value 222.

As illustrated in FIG. 2D, depending on a result of a comparison between registry data 218 and criteria 220, network device 110 may calculate a corresponding risk value 222. For example, when registry data 218 indicates that the vessel is overdue for an annual inspection and such data is applied to whether an annual inspection for the vessel is overdue, network device 110 may assign a risk value (e.g., 10) towards the calculation of the sub-score. Other applications of different registry data 218 (e.g., annual inspection for vessel is due in 28 days, etc.) and different criteria 220 (e.g., is annual inspection for vessel due within 30 days?, etc.) are also shown in FIG. 2D, which may yield a corresponding risk value 222 (e.g., 5, 1, etc.). Risk values 222 are exemplary and may be configurable in terms of numerical value, for example. According to some exemplary embodiments, a risk value may not be correlated to a single criterion. For example, the age of the vessel in combination with when the annual inspection is due may yield one or multiple risk values.

According to various exemplary embodiments, the criteria or rules may relate various aspects of the vessel, such as detention, inspections, surveys, insurance information, banking information, active issues relating to equipment of the vessel, dispensation information (e.g., active, resolved), vessel profile information, and/or other facets of the vessel and/or its operation relating to sea-worthiness, safety, and/or compliance from which a degree of risk may be determined. According to various exemplary embodiments, the criteria or rules may include arguments (e.g., a time period; a threshold value (e.g., a numerical value pertaining to a frequency or number of a configurable item, state, or condition, etc.); presence of a configurable item, state, or condition; absence of a configurable item, state, or condition; expiration of, failure to respond, etc.).

Referring to FIG. 2E, network device 110 may calculate a risk level based on each sub-score 225 of the vessel. For example, as mentioned, network device 110 may include criteria or rules that pertain to certain categories of data, a source of data, and/or an instance of data. As such, network device 225 may calculate a sub-risk value or score pertaining to each category of data, source of data, and/or instance of data.

According to an exemplary implementation, network device 110 may calculate the risk level based on a summation of the sub-scores or values pertaining to risk of the vessel. According to another exemplary implementation, network device 110 may calculate a risk level based on an average of the sub-scores. According to still other exemplary implementations, network device 110 may calculate a risk level based on a weighted average of the sub-scores. For example, a sub-score associated with a source of data or a category of data (e.g., inspection data) may be assigned a greater weight than a sub-score associated with another source of data or another category of data (e.g., vessel type data). According to various exemplary embodiments, the risk level may be a numerical value or not a numerical value, such as a level (e.g., high, medium, etc., a color, or other indicator), as previously described. According to an exemplary embodiment, the risk level may be considered an overall or generalized risk associated with the vessel.

Referring to FIG. 2F, network device 110 may rank vessels according to their risk levels 230. For example, network device 110 may rank the vessel and associated risk level relative to other vessels and associated risk levels. According to some exemplary embodiments, the ranking of risk may include assigning the vessel to a tier or a level of risk, as described herein. In this way, the vessel detention prevention and risk assessment service may identify vessels of a particular risk level or tier, and initiate an action to reduce or eliminate the risk based on the underlying factors contributing to the risk of the vessel, as described herein.

Referring to FIG. 2G, network device 110 may invoke an action responsive to the risk level and/or ranking 235. According to an exemplary embodiment, the action may depend on the risk level and/or ranking. For example, network device 110 may be configured to notify a designated person ashore (DPA) and/or another entity or person associated with the vessel regarding the risk level and/or ranking. By way of further example, for vessels that have been determined to be at a configurable threshold level of risk and/or ranking (e.g., high or highest level of risk), network device 110 may generate and transmit a message, which includes risk level and/or ranking information, to end device 150. The message may be an email, a text message, a telephone call, or other suitable form of communication. Network device 110 may be configured to actively monitor and follow-up regarding a response from the client/operator, initiate a scheduling of an inspection, or another type of remedial measure.

According to another exemplary embodiment, the action may not depend on the risk level and/or ranking. For example, network device 110 may make available to the operator of the vessel and/or another authorized person or entity, the risk level and/or ranking information, and a vessel summary that indicates a profile of the vessel via an online portal. The vessel summary may include inspection history of the vessel (e.g., annual safety inspection (ASI), PSC inspection, Classification Society inspection, and/or other entity's inspection), future inspection due date, statistics of the vessel compared to fleet average (e.g., vessel compared to ASI and PSC averages), dispensations (e.g., active, closed), certification data, insurance and mortgage information, and/or other items of relevance pertaining to the vessel. The online portal may also provide information regarding vessels under a common operator, such as risk levels for each vessel and other metrics as described herein (e.g., dispensations, certification data, detentions, inspections, etc.) that may be used for comparisons between the vessels.

Although FIGS. 2A-2G illustrate an exemplary embodiment of a process of the vessel detention prevention and risk assessment service, according to other exemplary scenarios, the vessel detention prevention and risk assessment service may perform additional operations, fewer operations, and/or different operations than those illustrated and described.

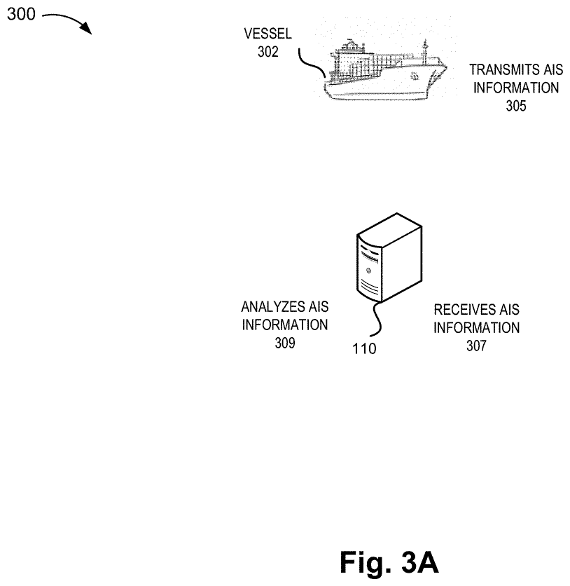

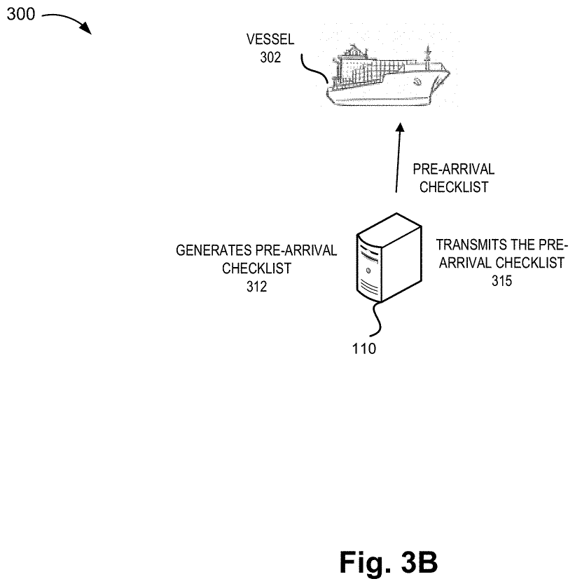

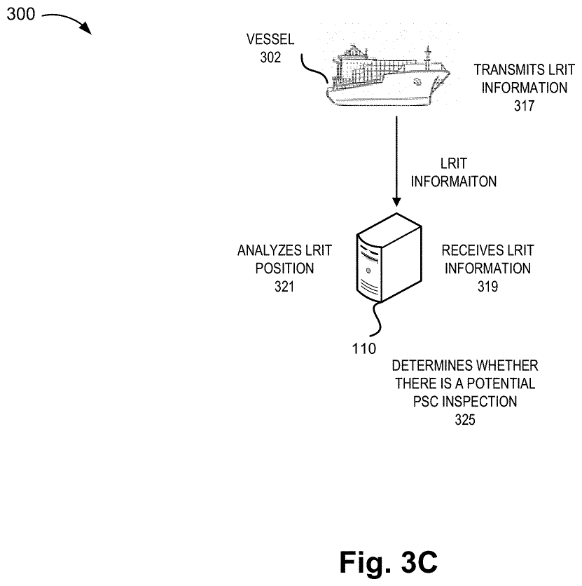

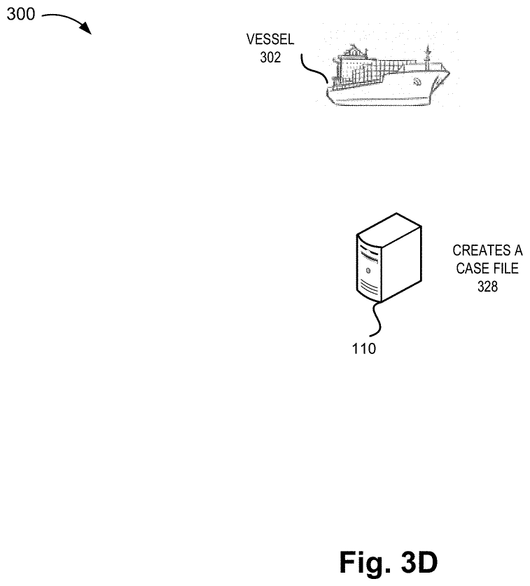

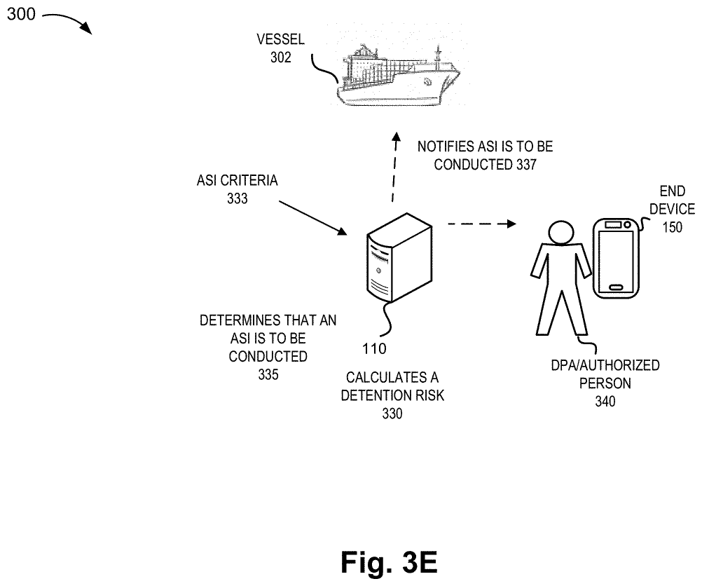

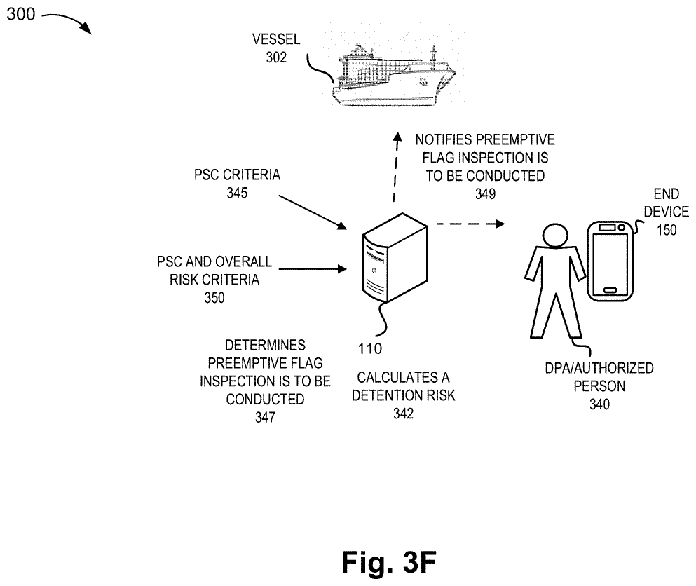

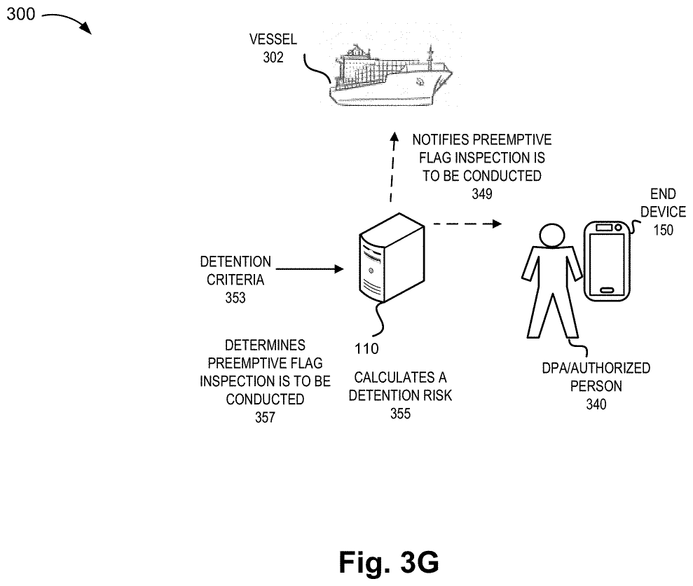

FIGS. 3A-3E are diagrams illustrating another exemplary process 300 of the vessel detention prevention and risk assessment service. As previously described, the vessel detention and risk assessment service may determine a risk of detention for a vessel, which is distinct from the overall risk, as previously described. For example, the risk of detention may indicate a risk of detention for a specific geographic area (e.g., zone, port, etc.) subject to enforcement by an enforcement entity. The geographic area may be a specific country and/or region subject to a specific MoU, regulations, and/or laws, for example.

Referring to FIG. 3A, a vessel 302 may transmit automatic identification system (AIS) position and voyage information 305. For example, the AIS information may include information indicating the position of vessel 302 (e.g., geographic coordinates) and time information (e.g., a timestamp). The AIS information may also include information indicating a next port or destination for vessel 302, departure information for heading to the next port or destination, expected time of arrival information (ETA) to the next port or destination, and/or other course or heading information relating to the journey of vessel 302 toward the next port or destination. For example, vessel 302 may be currently located near Florida, USA, and its next destination may be the port of Singapore. Vessel 302 may continually update the AIS position and voyage information.

As illustrated, network device 110 may receive the AIS position and voyage information 307. For example, an intermediary network (e.g., satellite and/or terrestrial) may capture the transmitted AIS position and voyage information, and a registry (e.g., network device 110) may obtain the AIS information. According to an exemplary embodiment, network device 110 may analyze the AIS position and voyage information 308. Based on the analysis, network device 110 determines that the next destination (e.g., Singapore) has different PSC authorities and different vessel targeting criteria relative to the PSC authorities and vessel targeting criteria of the vessel's 302 current location (e.g., Florida, USA).

Referring to FIG. 3B, network device 110 may generate a Dynamic Pre-Arrival Checklist (PAC) 312 for vessel 302. The Dynamic PAC may include a list of the most commonly found PSC findings for that specific port (e.g., Singapore). For example, network device 110 may determine from PSC data 208 the most commonly occurring PSC findings. In cases where the destination port does not have any reported PSC findings for the defined time period, network device 110 may identify the most commonly found PSC finding for that port's country. Also, if the country does not have reported PSC findings within a configurable look-back period, then network device 110 may determine the mostly commonly found PSC findings for that port's MoU.

Network device 110 may transmit the Dynamic PAC to vessel 302. For example, network device 110 may email to vessel 302 the Dynamic PAC. In this way, a crew member of vessel 302 (or other authorized person, such as the DPA, etc.) may review this information prior to arrival at that destination, and consequently reduce the risk of PSC detention of vessel 302. Network device 110 may limit communicating the same information during a defined time period (e.g., once every 30 days or another configurable time frame).

Referring to FIG. 3C, vessel 302 may transmit Long Range Identification and Tracking (LRIT) position information 317 to a device of a registry (e.g., network device 110). Network device 110 may receive the LRIT information 319. Based on receiving the LRIT information, network device 110 may analyze and/or compare the LRIT position 321 to defined geographic zones (e.g., areas that may be inclusive of specific MoUs). Network device 110 may determine if vessel 302 is subject to possible PSC inspection 325 upon arrival at its next location. Network device 110 may also analyze the LRIT position compared to the AIS position and voyage information. For example, network device 110 may confirm that a case file has been created for that MoU, and if not, to create a case file, as described herein.

Referring to FIG. 3D, network device 110 may create a case file 328 for vessel 302 and the associated next port or destination. For example, responsive to receiving the AIS position and voyage information, network device 110 may analyze the AIS information and determine that vessel 302 will be subject to a potential PSC inspection upon arrival at its next location. The creation of the case file may include, for example, the generation and storage of a file that may include vessel profile information, applicable regulations, laws, and/or an MoU associated with the location of relevance, an overall risk score calculated for vessel 302 on that date, and/or other configurable information. Additionally, or alternatively, the case file may indicate to network device 110 to perform tasks in support of the vessel detention prevention and risk assessment service for vessel 302, as described herein.

As a part of the creation process, according to an exemplary embodiment, network device 110 may determine that a case file has not already been created for vessel 302 and the associated next destination. Network device 110 may further determine that a case file was previously created for vessel 302 and the associated next port or destination, but the activity of the case file is not within a certain configurable time window, such that network device 110 may create the (new) case file. For example, the previously created case file may now be closed or expired (e.g., out of date). According to an exemplary embodiment, after creation of the case file, network device 110 may update the case file over time responsive to developments that may occur until the case file is closed. Users may also update the case file over time responsive to developments that may occur as well as close the case file once conditions have been met or the purpose of the case file is no longer relevant.

According to an exemplary embodiment, network device 110 may automatically close the case file when a criterion is satisfied. For example, network device 110 may close the case file when the overall risk level of vessel 302 satisfies a threshold risk level, as described herein. By way of further example, when the overall risk level is equal to or below a medium overall risk level, network device 110 may close the case file pertaining to risk of detention.

Referring to FIG. 3E, while the case file may be open, network device 110 may calculate a detention risk 330 for vessel 302. According to various exemplary embodiments, network device 110 may apply one or multiple criteria to identify detention risk 312. For example, network device 110 may apply ASI criteria 333 to determine detention risk 312. Network device 110 may use registry data 204 to determine when the next ASI is due for vessel 302. When vessel 302 is due for a next ASI within a configurable time period, network device 110 may determine that there is a detention risk that requires action. As an example, when vessel 302 is due for a next ASI within 90 days (or another time period), network device 110 may determine that an ASI is to be conducted 335.

As further illustrated in FIG. 3E, network device 110 may notify vessel 302, the operator, a DPA, and/or another authorized entity or person 340 that an ASI is to be conducted 337. Network device 110 may automatically request scheduling of the ASI or the ASI may be scheduled by the operator, the DPA, or another authorized entity or person. Thereafter, the ASI may be conducted, and depending on the outcome of the ASI, network device 110 may monitor the case file until criterion is met or the case file is closed by a user or by network device 110. Network device 110 may automatically generate and transmit communications to vessel 302, the DPA, the operator, and/or another authorized entity or person 340 during the monitoring to ensure that any detention risk is resolved. Upon such time, network device 110 or a user may close the case file.

Referring to FIG. 3F, when vessel 302 is not due for a next ASI within the configurable time period, network device 110 may apply additional or other criteria to calculate a detention risk 342. For example, network device 110 may apply PSC criteria 345 to determine detention risk 342 for vessel 302. Network device 110 may use PSC data 208 associated with vessel 302 to determine whether a PSC inspection associated with the next port or destination and applicable laws, regulations, and/or an MoU has ever been conducted for vessel 302. When network device 110 determines that vessel 302 has never undergone the PSC inspection, network device 110 may determine that a preemptive flag inspection is to be conducted 347. Network device 110 may notify vessel 302, the operator, a DPA, and/or another authorized entity or person 340 that a preemptive inspection is to be conducted 349. Thereafter, the preemptive flag inspection may be scheduled and conducted, and depending on the outcome of the preemptive flag inspection, network device 110 may monitor the case file until criterion is met or the case file is closed by a user or network device 110. Network device 110 may automatically generate and transmit communications to vessel 302, the DPA, the operator, and/or another authorized entity or person 340 during the monitoring to ensure that any detention risk is resolved. Upon such time, network device 110 or a user may close the case file.

According to another example, network device 110 may apply PSC and overall risk criteria 350 to determine a risk of detention for vessel 302. For example, when vessel 302 has an overall risk score or level (e.g., satisfies a minimum threshold overall risk score or level) and has not undergone a PSC inspection associated with the next port or destination and applicable laws, regulations, and/or an MoU within a first threshold time period, network device 110 may determine that a preemptive flag inspection is to be conducted 347. For example, a vessel with a high or highest overall risk score level or ranking and the vessel has not undergone the PSC inspection pertaining to the next port or destination in at least six months or some other time period, network device 110 may determine that a preemptive flag inspection is to be conducted for vessel 302. In a manner similar to that previously described, network device 110 may provide notification and monitoring services. The minimum threshold overall risk score or level and/or the first threshold time period may be configurable. Additionally, or alternatively, the minimum threshold overall risk score or level and/or the first threshold time period may be different between vessels depending on historical information associated with the vessel, or other criteria such as vessel type. For example, previous detentions, results of previous inspections, active dispensation history, and/or other criteria may be used as a basis to configure the minimum threshold overall risk score/level and/or the first threshold time period.

According to yet another example, when vessel 302 has not undergone a PSC inspection associated with the next port or destination and applicable laws, regulations, and/or an MoU within a second threshold time period regardless of the vessel's overall risk score or level, network device 110 may determine that a preemptive flag inspection is to be conducted 347. For example, if vessel 302 that has not undergone the PSC inspection pertaining to the next port or destination in at least nine months or some other time period, network device 110 may determine that a preemptive flag inspection is to be conducted. The second threshold time period may be configurable. Additionally, the second threshold time period may be different between vessels depending on historical information associated with the vessel, or other criteria such as vessel type, as described herein. Network device 110 may provide notification and monitoring services, as described herein.

Referring to FIG. 3G, according to still other examples, network device 110 may apply historical detention criteria 353 to determine a risk of detention 355 for vessel 302. For example, when network device 110 determines that vessel 302 has undergone past detention by any PSC authority associated with the next port or any other port, destination, or an MoU, within a third threshold time period, network device 110 may determine that a preemptive flag inspection is to be conducted 357. For example, if vessel 302 has undergone a detention by a PSC authority associated with the next port, destination, or an MoU within the last eighteen months (or other time period), network device 110 may determine that vessel 302 is to undergo a preemptive flag inspection.

Additionally, or alternatively, when network device 110 determines that vessel 302 has undergone past detention by any PSC authority (other than the enforcement entity associated with the next port, destination, or an MoU), within a fourth threshold time period, network device 110 may determine that a preemptive flag inspection is to be conducted 357. For example, if vessel 302 has undergone a past detention by a PSC entity not associated with the next port, destination, or an MoU within the last twelve months (or other time period), network device 110 may determine that vessel 302 is to undergo a preemptive flag inspection. The third threshold time period and the fourth threshold time period may be configurable. Additionally, the third threshold time period and/or the fourth threshold time period may be different between vessels depending on historical information associated with the vessel or other criteria such as vessel type, as described herein. Network device 110 may provide notification and monitoring services, as described herein.

Although FIGS. 3A-3G illustrate an exemplary embodiment of a process of the vessel detention prevention and risk assessment service, according to other exemplary scenarios, the vessel detention prevention and risk assessment service may perform additional operations, fewer operations, and/or different operations than those illustrated and described. For example, network device 110 may apply additional, different, and/or fewer criteria to determine whether there is a detention risk for vessel 302 that may warrant an inspection and/or other corrective action (e.g., certification, etc.). For example, a different combination of data pertaining to when a last ASI was performed, a last detention occurred, a last inspection relating to the next port or destination, and/or other historical information (e.g., frequency of active dispensations, type of issues found during past inspections, etc.) may be used as a basis to ascertain the detention risk.

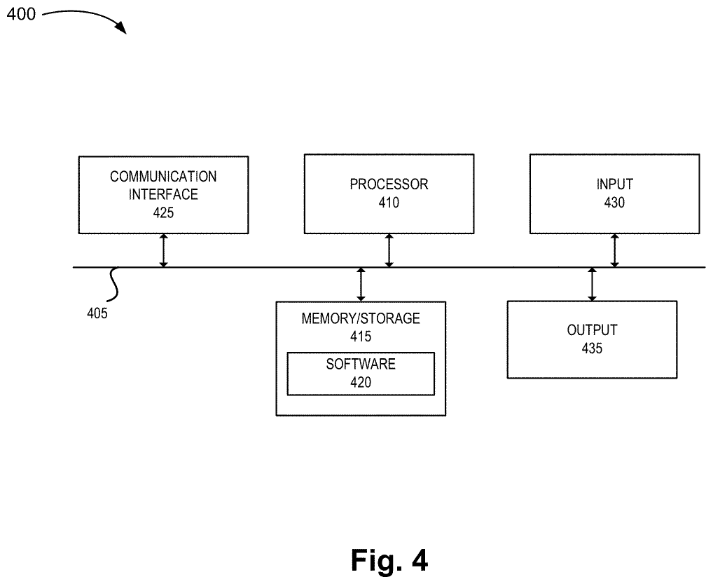

FIG. 4 is a diagram illustrating exemplary components of a device 400 that may correspond to one or more of the devices described herein. For example, device 400 may correspond to network device 110 and end device 150, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 410 may be implemented as hardware (e.g., a microprocessor, etc.) and may include one or multiple memories (e.g., cache, etc.). Processor 410 may include a dedicated element (e.g., a dedicated microprocessor) and/or a non-dedicated element (e.g., a non-dedicated/shared microprocessor, etc.).

Processor 410 may control the overall operation or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques including, for example, multithreading, parallel processing, pipelining, interleaving, etc.

Memory/storage 415 includes one or multiple memories and/or one or multiple other types of storage mediums. For example, memory/storage 415 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory (e.g., a NAND flash, a NOR flash, etc.), and/or some other type of memory. Memory/storage 415 may include a hard disk (e.g., a magnetic disk, an optical disk, a magneto-optic disk, a solid state disk, etc.), and/or a nanotechnology-based storage medium. Memory/storage 415 may include a drive for reading from and writing to the storage medium.

Memory/storage 415 may be external to and/or removable from device 400, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). Memory/storage 415 may store data, software, and/or instructions related to the operation of device 400.

Software 420 includes an application or a program that provides a function and/or a process. Software 420 may also include firmware, middleware, microcode, hardware description language (HDL), and/or other form of instructions. As an example, with reference to network device 110, software 420 may include an application that, when executed by processor 410, manages a database or other repository that stores and manages the information, as described herein. According to another example, with reference to network device 110, software 420 may include an application that, when executed by processor 410, provides the vessel detention prevention and risk assessment service, as described herein.

Communication interface 425 permits device 400 to communicate with other devices, networks, systems, and/or the like. Communication interface 425 includes one or multiple interfaces of one or multiple types (e.g., optical, wireless, wired). Communication interface 425 may include one or multiple transmitters and receivers, or transceivers. Communication interface 425 may operate according to a protocol stack and a communication standard. Communication interface 425 may include an antenna. Communication interface 425 may include various processing logic or circuitry (e.g., multiplexing/de-multiplexing, filtering, amplifying, converting, error correction, etc.).

Input 430 permits an input into device 400. For example, input 430 may include a keyboard, a mouse, a display, a touchscreen, a touchless screen, a button (e.g., a power button, a disaster recovery button, a virtual button, etc.), a switch, an input port, speech recognition logic, and/or some other type of visual, auditory, tactile, etc., input component. Output 435 permits an output from device 400. For example, output 435 may include a speaker, a display, a touchscreen, a touchless screen, a light, an output port, and/or some other type of visual, auditory, tactile, etc., output component.

Device 400 may perform a process, a function and/or a step of the process, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 cause processor 410 to perform a process, the function, and/or the step of the process, as described herein. Alternatively, for example, according to other implementations, device 400 may perform a process, a function, and/or a step of the process, as described herein based on the execution of hardware (processor 410, etc.).

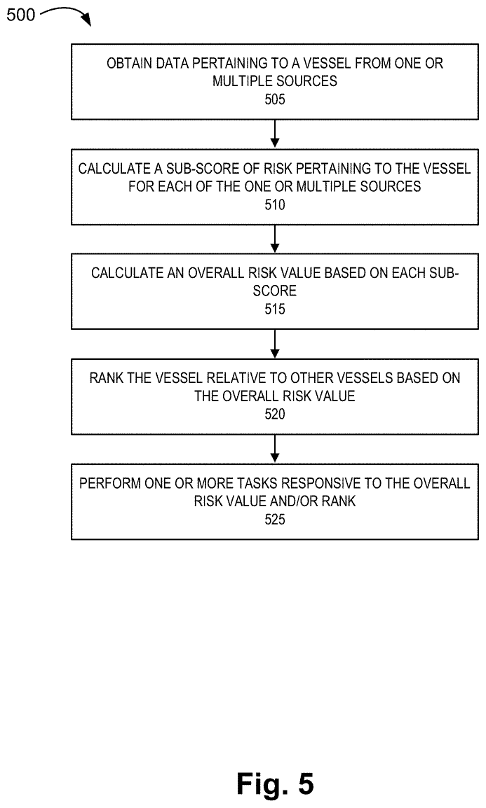

FIG. 5 is a flow diagram illustrating an exemplary process 500 of the vessel detention prevention and risk assessment service. According to an exemplary embodiment, network device 110 may perform steps of process 500. For example, processor 410 may execute software 420 to perform a step illustrated in FIG. 5 and described herein. Alternatively, a step illustrated in FIG. 5 and described herein, may be performed by execution of only hardware. Further, a step may be only partially performed by the execution of software 420 or only hardware.

Referring to FIG. 5, in block 505, network device 110 may obtain data pertaining to a vessel from one or multiple sources. For example, network device 110 may obtain registry data, PSC data, and/or class society data, as described herein.

In block 510, network device 110 may calculate a sub-score of risk pertaining to the vessel for each of the one or multiple sources. For example, network device 110 may include a risk assessment algorithm that calculates the sub-score for selected instances of data of relevance associated with each source, as described herein. As previously described, each instance of data of a source may or may not be equally weighted when calculating the sub-score.

In block 515, network device 110 may calculate an overall risk value based on each sub-score of risk. For example, network device 110 may calculate the overall risk value based on a summation of the sub-score(s), an average of the sub-scores, and/or a weighting associated with each sub-score/source.

In block 520, network device 110 may rank the vessel relative to other vessels based on the overall risk value. For example, network device 110 may rank the vessel according to tier or level of risk, such as by degree of overall risk (e.g., low, medium, high, very high; colors representative of different degrees of overall risk; or use of other nomenclatures/indicators).

In block 525, network device 110 may perform one or multiple tasks responsive to the overall risk value and/or rank. For example, network device 110 may perform various actions depending or not depending on the overall risk value and/or risk level. For example, network device 110 may provide a notification service that notifies the DPA or other authorized person about the overall risk value and/or risk level; make available a vessel summary via an online portal to an authorized person (e.g., DPA, an operator, etc.); request a scheduling of an inspection; or request some other corrective action to be performed to address or decrease the overall risk value and/or risk level.

FIG. 5 illustrate an exemplary process 500 of the vessel detention prevention and risk assessment service, however, according to other embodiments, process 500 may include additional operations, fewer operations, and/or different operations than those illustrated in FIG. 5 and described herein.

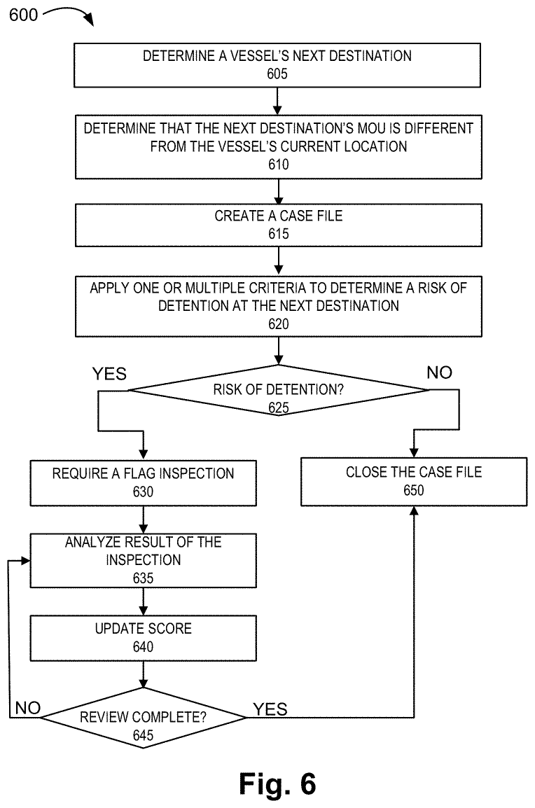

FIG. 6 is a flow diagram illustrating an exemplary process 600 of the vessel detention prevention and risk assessment service. According to an exemplary embodiment, network device 110 may perform steps of process 600. For example, processor 410 may execute software 420 to perform a step illustrated in FIG. 6 and described herein. Alternatively, a step illustrated in FIG. 6 and described herein, may be performed by execution of only hardware. Further, a step may be only partially performed by the execution of software 420 or only hardware.

Referring to FIG. 6, in block 605, network device 110 may determine a vessel's next destination. For example, network device 110 may receive AIS position and voyage information that indicates a next port or destination of the vessel. The AIS position and voyage information may also indicate the vessel's current location and course or heading information.

In block 610, network device 110 may determine that the next destination's MOU is different from the vessel's current location. For example, network device 110 may make this determination based on registry data and/or other information (e.g., PSC data, etc.).

In block 615, network device 110 may create a case file. The case file may include data pertaining to the vessel. The case file may indicate to network device 110 to perform tasks in support of the vessel detention prevention and risk assessment service for the vessel.

In block 620, network device 110 may apply one or multiple criteria to determine a risk of detention of the vessel at the next destination. For example, network device 110 may apply various criteria that may relate to when the last ASI occurred; how long until the next ASI is to occur; the overall risk value and/or risk level of the vessel; whether the vessel has ever been subject to an inspection where the laws of the next destination have been applied; whether the vessel has been subject to an inspection, where the laws of the next destination have been applied, within a certain time period; and other criteria, as described herein.

In block 625, network device 110 may determine whether a risk of detention for the vessel is present based on the application of the one or multiple criteria. When network device 110 determines that a risk of detention for the vessel is present (block 625—YES), network device 110 may require a flag inspection (block 630). For example, the flag inspection may be an ASI, a preemptive inspection, or some other action that may decrease or eliminate the risk of detention (bock 630). Network device 110 may provide notification services to persons of relevance (e.g., a registry entity, a DPA of the vessel, etc.) regarding the risk of detention, and may assist or coordinate a scheduling of the inspection or other risk minimizing action.

Network device 110 may receive data regarding the result of the inspection from an inspecting officer or person. In block 635, network device 110 may automatically analyze the result or findings of the inspection or other risk minimizing action. In some instances, a person associated with network device 110 may contribute to the analysis. In block 640, based on the analysis, network device 110 may update the sub-scores of the vessel taking the results of the latest flag inspection into account. In block 645, network device 110 may determine whether the case file review is complete. For example, network device 110 may determine whether further monitoring and analysis of data is to be performed based on the updated sub-scores. Network device 110 may also identify any findings that may need to be corrected and monitor their dispensations. If the review is not complete (block 645—NO), network device 110 may continue to monitor, receive, and analyze data regarding these issues (block 635). If there are no longer any issues (block 645—YES), network device 110 may close the case file or the case file may be closed by an authorized user after review (block 650).

Referring back to block 625, when network device 110 determines that a risk of detention for the vessel is not present (block 625—NO), network device 110 may close the file or the case file may be closed by an authorized user after review (block 650).

FIG. 6 illustrate an exemplary process 600 of the vessel detention prevention and risk assessment service, however, according to other embodiments, process 600 may include additional operations, fewer operations, and/or different operations than those illustrated in FIG. 6 and described herein. For example, according to other exemplary embodiments, process 600 may omit blocks 615 and 650. As an example, block 650 may be a step that ends process 600.

The foregoing description of embodiments provides illustration but is not intended to be exhaustive or to limit the embodiments to the precise form disclosed. In the preceding description, various embodiments have been described with reference to the accompanying drawings. However, various modifications and changes may be made thereto, and additional embodiments may be implemented, without departing from the broader scope of the invention as set forth in the claims that follow. The description and drawings are accordingly to be regarded as illustrative rather than restrictive.

In addition, while a series of blocks has been described with regard to the processes illustrated in FIGS. 5 and 6, the order of the blocks may be modified according to other embodiments. Further, non-dependent blocks may be performed in parallel. Additionally, other processes and/or operations described in this description may be modified and/or non-dependent operations may be performed in parallel.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

Embodiments described herein may be implemented in many different forms of software executed by hardware. For example, a process or a function may be implemented as “logic,” a “component,” or an “element.” The logic, the component, or the element, may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Use of the phrase “maritime law” is intended to include at least one of a law, a regulation, a convention, or an MoU. The law, regulation, convention, or MoU may be international, regional, or local in scope or geographic reach.

Use of the phrase “next destination” is intended to include a port. The port may be onshore, or offshore mooring, for example. The port may include a geographic water area where loading of cargo onto a vessel and unloading of cargo from the vessel may take place.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple devices.

No element, act, or instruction described in this description should be construed as critical or essential to the embodiments described herein unless explicitly described as such.

All structural and functional equivalents to the elements of the various aspects set forth in this disclosure that are known or later come to be known are expressly incorporated herein by reference and are intended to be encompassed by the claims.

What is claimed is:

1. A method comprising:
determining, by a network device, a next destination of a vessel;
determining, by the network device, that the next destination has a maritime law different from a maritime law of a current location of the vessel;
applying, by the network device, one or multiple criteria to determine whether there is a detention risk of the vessel at the next destination;
determining, by the network device in response to the applying, that there is the detention risk of the vessel; and
performing, by the network device, one or multiple actions to at least minimize the detention risk of the vessel.

2. The method of claim 1, further comprising:
receiving, by the network device, automatic identification system (AIS) information pertaining to the vessel, wherein the AIS information includes the next destination and the current location of the vessel.

3. The method of claim 1, further comprising:
creating, by the network device, a case file pertaining to the vessel based on determining that the next destination has the maritime law different from the maritime law of the current location of the vessel.

4. The method of claim 1, wherein the one or multiple criteria indicate a presence of the detention risk or an absence of the detention risk, and the method further comprising:
receiving, by the network device from the vessel, Long Range Identification and Tracking (LRIT) position information; and
comparing, by the network device, an LRIT position of the vessel to one or multiple geographic zones associated with one or multiple maritime laws.

5. The method of claim 4, wherein the applying comprises:
comparing, by the network device, the one or multiple criteria to profile information of the vessel; and
determining, by the network device, whether one or multiple instances of data included in the profile information satisfy or do not satisfy the one or multiple criteria.

6. The method of claim 5, wherein the profile information includes at least one of inspection information or detention information about the vessel.

7. The method of claim 4, further comprising:
calculating, by the network device, an overall risk value of the vessel; and wherein one of the one or multiple criteria includes the overall risk value.

8. The method of claim 1, wherein the performing comprises at least one of:
notifying, by the network device, a person associated with the vessel via an end device regarding the detention risk,
transmitting, by the network device to the vessel, a pre-arrival checklist that includes one or more issues historically enforced at the next destination, or
causing, by the network device, an inspection to be conducted for the vessel, wherein the at least one of the notifying or the causing is performed before an arrival of the vessel to the next destination.

9. A network device comprising:
a processor, wherein the processor is configured to:
determine a next destination of a vessel;
determine that the next destination has a maritime law different from a maritime law of a current location of the vessel;
apply one or multiple criteria to determine whether there is a detention risk of the vessel at the next destination;
determine that there is the detention risk of the vessel; and
perform one or multiple actions to at least minimize the detention risk of the vessel.

10. The network device of claim 9, wherein the processor is further configured to:
receive automatic identification system (AIS) information pertaining to the vessel, wherein the AIS information includes the next destination and the current location of the vessel.

11. The network device of claim 9, wherein the processor is further configured to:
create a case file pertaining to the vessel based on determining that the next destination has the maritime law different from the maritime law of the current location of the vessel.

12. The network device of claim 9, wherein the one or multiple criteria indicate a presence of the detention risk or an absence of the detention risk, and the processor is further configured to:
receive from the vessel Long Range Identification and Tracking (LRIT) position information; and
compare an LRIT position of the vessel to one or multiple geographic zones associated with one or multiple maritime laws.

13. The network device of claim 12, wherein when applying, the processor is further configured to:
compare the one or multiple criteria to profile information of the vessel; and
determine whether one or multiple instances of data included in the profile information satisfy or do not satisfy the one or multiple criteria.

14. The network device of claim 13, wherein the profile information includes at least one of inspection information or detention information about the vessel.

15. The network device of claim 12, wherein the processor is further configured to:
calculate an overall risk value of the vessel; and wherein one of the one or multiple criteria includes the overall risk value.

16. The network device of claim 9, wherein when performing, the processor is further configured to at least one of:
notify a person associated with the vessel via an end device regarding the detention risk,
transmit to the vessel a pre-arrival checklist that includes one or more issues historically enforced at the next destination, or
cause an inspection to be conducted for the vessel, wherein the at least one of the notification or the causing is performed before an arrival of the vessel to the next destination.

17. A non-transitory, computer-readable storage medium storing instructions executable by a processor of a device, which when executed cause the device to:
determine a next destination of a vessel;
determine that the next destination has a maritime law different from a maritime law of a current location of the vessel;
apply one or multiple criteria to determine whether there is a detention risk of the vessel at the next destination;
determine that there is the detention risk of the vessel; and
perform one or multiple actions to at least minimize the detention risk of the vessel.

18. The non-transitory, computer-readable storage medium of claim 17, wherein the instructions to perform further comprise instructions, which when executed cause the device to at least one of:
notify a person associated with the vessel via an end device regarding the detention risk,
transmit to the vessel a pre-arrival checklist that includes one or more issues historically enforced at the next destination, or
cause an inspection to be conducted for the vessel, wherein the at least one of the notification or the causing is performed before an arrival of the vessel to the next destination.

19. The non-transitory, computer-readable storage medium of claim 17, wherein the one or multiple criteria indicate a presence of the detention risk or an absence of the detention risk, and wherein the instructions further comprise instructions, which when executed cause the device to:
receive from the vessel Long Range Identification and Tracking (LRIT) position information; and
compare an LRIT position of the vessel to one or multiple geographic zones associated with one or multiple maritime laws.

20. The non-transitory, computer-readable storage medium of claim 19, wherein the instructions further comprise instructions, which when executed cause the device to:
compare the one or multiple criteria to profile information of the vessel; and
determine whether one or multiple instances of data included in the profile information satisfy or do not satisfy the one or multiple criteria.
